(19) United States
(12) Patent Application Publication
(10) Pub. No.: US 2026/0311486 A1
(43) Pub. Date: Oct. 8, 2026

(54) COMPUTER SYSTEM AND METHOD FOR MARITIME SURVEILLANCE AND SATELLITE-BASED EARTH OBSERVATION OF OBJECTS USING NADIR-OBLIQUE IMAGE MATCHING

(71) Applicant: MDA Systems Ltd., Richmond (CA)

(72) Inventors: Adam Schneider, Vancouver (CA); Hans Wehn, Bowen Island (CA); Giona Matasci, Vancouver (CA)

(21) Appl. No.: 19/483,750

(22) PCT Filed: Apr. 26, 2024
(86) PCT No.: PCT/CA2024/050559

§ 371 Date: Nov. 12, 2025

Related U.S. Application Data
(60) Provisional application No. 63/502,480, filed on May 16, 2023.

(51) Int. Cl. G06V 20/52; G06V 10/74; G06V 10/774; G06V 10/778; G06V 10/82; G06V 10/94

(52) U.S. Cl. CPC G06V 20/52; G06V 10/761; G06V 10/774; G06V 10/7788; G06V 10/82; G06V 10/945

(57) ABSTRACT

Systems, methods, and computer-readable media for vessel identification are provided. The system includes a data storage device storing: a database of optical oblique images each containing a known candidate vessel having a known unique vessel identifier; and an optical nadir satellite image containing an unknown vessel. The system further includes a processor configured to execute a nadir-oblique image matcher configured to: compare, via a neural network, the nadir image to oblique images in the database including determining a similarity score between the nadir image and a respective oblique image; output, via the neural network, a ranked list of the oblique images based on the determined similarity scores; and assign a known unique vessel identifier to the nadir image based on the ranked list.

### TECHNICAL FIELD

The following relates generally to maritime surveillance and satellite-based earth observation, and more particularly to systems and methods for maritime surveillance and satellite-based earth observation using computer vision and machine learning.

### INTRODUCTION

Although ground-based and aircraft platforms may be used, satellites provide a great deal of the remote sensing imagery commonly used today. Satellites have several unique characteristics which make them particularly useful for remote sensing of the Earth's surface. Approaches to performing such remote sensing includes using imaging techniques, such as high resolution optical imaging and synthetic aperture radar (“SAR”) imaging.

One particular domain in which satellite imaging is used is earth observation. Various problems in earth observation may benefit from satellite imaging. One such example is vessel detection (including the ability to detect non-transmitting dark ships, illegal fishing activity, etc.). More generally, it may also be desirable to track an object (e.g., a marine vessel) across multiple images or to confirm that an object present in one image is the same as a known object present in another image.

In some cases, available data may include optical near-nadir-looking satellite images and oblique images of objects (e.g., vessels) acquired from earth/ground or low altitude airborne platforms. The objects in such oblique images may be “known”, in the sense that a respective oblique image containing an object may be associated with a unique object identifier that identifies the object. It may be desirable to confirm an identity of an object in an overhead or nadir satellite image using available oblique images containing objects with known identity.

Accordingly, there is a need for an improved system and method for maritime surveillance and satellite-based earth observation that overcomes at least some of the disadvantages of existing systems and methods.

### SUMMARY

A computer system for computer vision-based maritime surveillance and identification of unknown vessels is provided. The system includes at least one data storage device storing: a database of optical oblique images each containing a known candidate vessel, each known candidate vessel having a known unique vessel identifier associated therewith that is stored in the database and which identifies the known candidate vessel; and an optical nadir satellite image containing an unknown vessel. The system further includes at least one processor configured to execute a nadir-oblique image matcher. The nadir-oblique image matcher is configured to: compare, via a neural network, the nadir image to a plurality of oblique images in the database, the comparing including determining a similarity score indicating a similarity level between the nadir image and a respective oblique image; output, via the neural network, a ranked list of the oblique images, the ranked list based on the determined similarity scores, wherein a higher ranking in the ranked list indicates a higher similarity score and greater likelihood of the known vessel in the oblique image being the same as the unknown vessel in the nadir image; and assign a known unique vessel identifier to the nadir image based on the ranked list.

The nadir-oblique image matcher may be further configured to store the nadir image and the newly assigned known vessel identifier in association with the nadir image in a database of nadir images containing known vessels for future use by a nadir-nadir image matcher.

The at least one processor may be further configured to execute a user interface module configured to display a graphical user interface including a graphical representation of the ranked list and receive a user input selecting a known oblique image from the ranked list, and wherein the assigning includes assigning, in response to the user input, the known vessel identifier associated with the selected known oblique image to the unknown nadir image.

The graphical representation of the ranked list may include, for each known oblique image in the ranked list, a visual representation of the known oblique image.

Assigning the known unique vessel identifier to the unknown nadir image may be performed automatically without user input by the nadir-oblique image matcher based on a similarity score of a known oblique image associated with the known unique vessel identifier exceeding a predetermined threshold similarity score.

The at least one processor may be further configured to execute a user interface module configured to: display a graphical user interface including the assignment of the known vessel identifier to the unknown nadir image and a visual representation of the known oblique image associated with the known unique vessel identifier and the unknown nadir image; and receive a user input confirming or rejecting the assignment.

The unique vessel identifier may be a maritime mobile service identify number.

The neural network may be a Siamese-like neural network configured to receive a plurality of image pairs as input, each image pair including the unknown nadir image and a known oblique image from the database, the Siamese-like neural network comprising two encoder branches having an identical architecture with different weights.

A trajectory including a time and location of the unknown vessel may be encoded with the unknown nadir image and used by the at least one processor to determine the plurality of known oblique images to which the unknown nadir image is compared by the nadir-oblique image matcher.

The plurality of known oblique images may represent a list of candidate vessels identified by a feasible vessel finder module based on a trajectory of unknown vessel in the unknown nadir image.

The at least one processor may be further configured to execute the feasible vessel finder module to obtain the list of candidate vessels.

The unknown nadir image may have only one time and location encoded therewith that is used to determine the plurality of known oblique images for comparison with the unknown nadir image via a trajectory analysis.

The Siamese-like neural network may include a first encoder branch pretrained with a nadir-nadir image dataset and a second encoder branch pretrained with an oblique-oblique dataset. After individual pretraining of the first and second branches, the first and second branches may then be trained together on a nadir-oblique image dataset. The nadir-oblique image dataset may comprise pairs of one nadir image and one oblique image.

A method of computer vision-based maritime surveillance and identification of unknown vessels is also provided. The method includes comparing, via a neural network, a cropped nadir image to at least one oblique image of a known vessel stored in an oblique imagery database, the comparing including determining a similarity score indicating a similarity level between the cropped nadir image and the compared oblique image, the oblique image containing a known candidate vessel having a known unique vessel identifier associated therewith that is stored in association with the oblique image and which identifies the known candidate vessel; outputting, via the neural network, a ranked list of the oblique images that were compared to the cropped nadir image, the ranked list based on the determined similarity scores, wherein a higher ranking in the ranked list indicates a higher similarity score and greater likelihood of the known vessel in the oblique image being the same as the unknown vessel in the nadir image; and assigning at least one unique vessel identifier to the cropped nadir image based on the ranked list. At least one non-transitory computer-readable storage medium storing processor executable instructions that, when executed by at least one processor, cause the at least one processor to perform the foregoing method is also provided.

The method may further include identifying a trajectory of the unknown vessel in the nadir image and using the trajectory to identify a subset of the oblique images in the oblique imagery database for comparison to the nadir image.

A method of training a nadir-oblique image matcher model for computer vision-based object tracking is also provided. The method includes pretraining an oblique image encoder branch for use in a nadir-oblique image matcher model, the oblique image matcher encoder branch trained in oblique-oblique image matching; pretraining a nadir image encoder branch for use in the nadir-oblique image matcher model, the nadir image encoder branch trained in nadir-nadir image matching; and training the nadir-oblique image matcher model using the nadir-nadir pretrained model and the oblique-oblique pretrained model, using pretrained weights obtained from pretraining the oblique image encoder branch and pretraining the nadir image encoder branch in the nadir-oblique image matcher model; wherein the nadir-oblique image matcher model includes separate oblique and nadir image encoder branches. At least one non-transitory computer-readable storage medium storing processor executable instructions that, when executed by at least one processor, cause the at least one processor to perform the foregoing method is also provided.

A computer system for computer vision-based identification of objects of unknown identity is provided. The system includes at least one data storage device storing: a database of optical oblique images each containing a known candidate object, each known candidate object having a known unique object identifier associated therewith that is stored in the database and which identifies the known candidate object; and an optical nadir satellite image containing an unknown object. The system further includes at least one processor configured to execute a nadir-oblique image matcher. The nadir-oblique image matcher is configured to: compare, via a neural network, the unknown nadir image to a plurality of known oblique images in the database, the comparing including determining a similarity score indicating a similarity level between the unknown nadir image and a respective known oblique image; output, via the neural network, a ranked list of the known oblique images, the ranked list based on the determined similarity scores, wherein a higher ranking in the ranked list indicates a higher similarity score and greater likelihood of the known object in the known oblique image being the same as the unknown object in the nadir image; and assign a known unique object identifier to the unknown nadir image based on the ranked list.

A method of computer vision-based maritime identification of objects of unknown identity is also provided. The method includes comparing, via a neural network, a cropped nadir image to at least one oblique image containing a known object stored in an oblique imagery database, the comparing including determining a similarity score indicating a similarity level between the cropped nadir image and the compared oblique image, the oblique image containing a known candidate object having a known unique object identifier associated therewith that is stored in association with the oblique image and which identifies the known candidate object; outputting, via the neural network, a ranked list of the oblique images that were compared to the cropped nadir image, the ranked list based on the determined similarity scores, wherein a higher ranking in the ranked list indicates a higher similarity score and greater likelihood of the known object in the oblique image being the same as the unknown object in the nadir image; and assigning at least one unique vessel identifier to the cropped nadir image based on the ranked list. At least one non-transitory computer-readable storage medium storing processor executable instructions that, when executed by at least one processor, cause the at least one processor to perform the foregoing method, is also provided.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computer system for vessel identification using nadir-oblique image matching, according to an embodiment;

FIG. 2 is a graph plotting oblique-oblique vessel image matching with SAFA-net training and testing accuracy, according to an embodiment;

FIG. 3 is a plot of oblique images illustrating oblique-oblique image matching results, wherein the left column with black box is the target vessel and right 5 columns are the top 1-5 selections by the model, according to an embodiment;

FIG. 4 is a graph plotting nadir-nadir image matching training and testing accuracy, according to an embodiment;

FIG. 5 is a histogram of similarity scores for positive and negative image pairs, for nadir-nadir image matching with SAFA-net, according to an embodiment;

FIG. 6 is a graph plotting PD and 1-PFa rates and precision, recall, and F1 scores versus threshold (top row) with PD versus PFa and precision versus recall (bottom row), according to an embodiment;

FIG. 7 is a graph plotting PD and 1-PFa rates and precision, recall, and F1 scores versus threshold (top row) with PD versus PFa and precision versus recall (bottom row), calculated for small ships (red), medium ships (green), and large ships (blue), for the nadir-nadir image matcher, according to an embodiment;

FIG. 8 is a graph plotting nadir-oblique image matching training and multi-image testing accuracy, according to an embodiment;

FIG. 9 is a histogram of similarity scores for positive and negative image pairs, for nadir-oblique image matching with SAFA-net, according to an embodiment;

FIG. 10 is a graph plotting PD and 1-PFa rates and precision, recall, and F1 scores versus threshold (top row) with PD versus PFa and precision versus recall (bottom row), calculated for small ships (red), medium ships (green), and large ships (blue), for the nadir-oblique image matcher, according to an embodiment;

FIG. 11 is a flow diagram of a method of object identification using nadir optical satellite images and oblique images, according to an embodiment;

FIG. 12 is a flow diagram of a method of training a nadir-oblique image matcher, such as the image matcher FIG. 1, according to an embodiment;

FIG. 13 is a block diagram of a computer system for vessel identification including a nadir-oblique image matcher, such as the nadir-oblique image matcher of FIG. 1, according to an embodiment;

FIG. 14 is a schematic diagram of a computer system for object identification using nadir-oblique image matching, according to an embodiment; and FIG. 15 is a schematic diagram of a Siamese-like network architecture for use in a nadir-oblique image matcher, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to maritime surveillance and satellite-based earth observation, and more particularly to systems and methods for maritime surveillance and satellite-based earth observation using computer vision and machine learning.

While many of the embodiments described herein are directed to marine vessel identification, it is to be understood that the systems and methods of the present disclosure may be used, in variations, to perform identification of other types of objects though nadir-oblique image matching and the applications of the systems and methods of the present disclosure are not limited to vessel detection. Thus, it is understood that reference in the present disclosure to “vessel” or “vessel detection” is merely one example and is meant to include any type of object suitable for nadir-oblique image matching as described herein.

The present disclosure provides systems and methods for tackling the vessel identification problem based on image sources using state-of-the-art machine learning and computer vision approaches from the sub-field of one-shot/low-shot image recognition.

Vessel identification as used herein and as performed using the systems and methods of the present disclosure may refer to vessel identification in absolute terms with the retrieval of an absolute identity (e.g., MMSI number or other unique vessel identifier) of the vessel of interest (e.g., from a large database of images). This may occur, for example, where a system operator is interested in inspecting a few vessels appearing in a given image, to check for their identity/characteristics from an existing vessel database.

Vessel identification as used herein and as performed using the systems and methods of the present disclosure may refer to vessel identification in relative terms by re-identifying a given vessel among a reduced list of candidates. In this case, the vessel identification may be used to uniquely re-identify the same vessel across multiple images, supporting the task of vessel tracking. This may happen at a short temporal scale, for example, where multiple images are acquired within a few hours along a maritime corridor where ships have to be re-identified and matched across acquisitions. A similar approach may be applied at a larger temporal and spatial window, for instance in the case of the search and tracking of a suspicious vessel that might have visited multiple ports or entered a monitored zone (vessel on a “watch list”), days or even months apart.

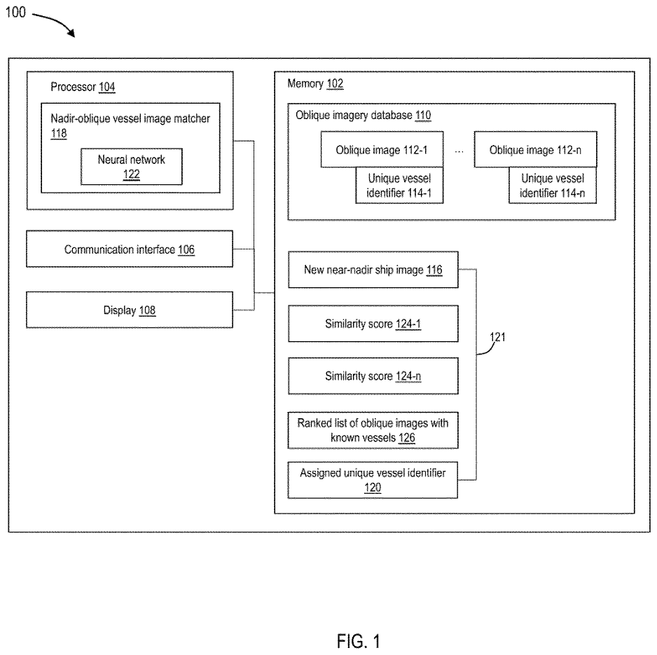

Referring now to FIG. 1, shown therein is a system 100 for vessel identification using nadir-oblique image matching, according to an embodiment.

In an embodiment, the system 100 uses optical satellite images to identify dark vessels by matching a new near-nadir satellite image to a database of oblique imagery of known vessel candidates.

The system, or a subset of components thereof, may be implemented as part of a larger vessel identification system (e.g., a platform to aid in dark vessel detection). For example, in an embodiment, the system 100 may be implemented along with one or more of a nadir-nadir image matcher and a SAR-SAR image matcher, where the outputs of multiple models each directed to different image source pairs are further processed to perform vessel identification.

The system 100 may include one or more computer devices. For example, the system 100 may include a plurality of computer devices in communication via a network connection. Further, components of the system 100 may be implemented at a single computer device, or across a plurality of computer devices.

In some embodiments, the system 100 includes at least one user computing device and at least one server computing device in communication via a network connection. The user device may execute an application that can interact with server-side software components (“services”) hosted by the server computing device. For example, the computer system 100 may execute a network-based software application that executes partially at the server computing device (via server-side software components) and partially at the user device (via client-side software components). In an embodiment, the client-side software components include a user interface (e.g., web-based user interface).

The system 100 includes a memory 102 and a processor 104 in communication with the memory 102.

The system 100 includes a communication interface 106 for transmitting and receiving data. The communication interface 106 may include a network interface.

The system 100 includes a display 108 for displaying data generated by the system 100. The display 108 may be located at a user device of the system 100.

The memory 102 stores a database 110 of oblique images (also referred to as “oblique imagery database”). Each oblique image in the database 110 contains a vessel. The oblique image may have been acquired from earth/ground or from a low altitude airborne platform. In an example, an oblique image may be an aerial photo captured at an angle of 40 to 45 degrees.

The database 110 also stores a unique vessel identifier for each oblique image. The unique vessel identifier identifies the vessel represented in the oblique image. In an embodiment, the unique vessel identifier is a maritime mobile service identify (“MMSI”) number. The unique vessel identifier is stored in the database 110 such that the unique vessel identifier is associated with (and thus retrievable based on) the oblique image (and thus the vessel represented in the oblique image).

Database 110 in FIG. 1 is shown to include oblique image 112-1 and oblique image 112-n. In variations, any suitable number of oblique images may be stored in the database 110 and used. The database 110 also stores unique vessel identifier 114-1 and unique vessel identifier 114-n, which are associated with oblique image 112-1 and 114-n, respectively. Oblique images 112-1 and 112-n may be referred to collectively as oblique images 112 and generically as oblique image 112.

Given that each oblique image in the database 110 has an associated unique vessel identifier identifying the vessel in the oblique image, such vessel is considered “known” (i.e., a “known vessel” or “known vessel candidate”, as its identity is known).

The memory 102 also stores a new nadir vessel image 116. The new nadir vessel image 116 contains an unknown vessel (also referred to as a “vessel of interest”). That is, the new nadir vessel image 116 contains a vessel whose identity is unknown and for which a user wants to determine or confirm an identity. The new nadir vessel image 116 is an optical satellite image. The optical satellite image may be a high resolution optical satellite image. In an example, the optical satellite image may be an approximately 30-60 cm/pixel image.

The optical satellite image may be an optical “near-nadir”-looking satellite image. Perfectly nadir means the satellite is looking directly downwards; however, this is only possible in the center of the image, and towards the edges of the images the viewing angle (i.e. “nadir angle”) is slightly greater. Moreover, most satellite images do not have a mean nadir angle of 0. For example, the mean nadir angle can vary up to ~35 degrees. Memory 102 may store a plurality of new nadir vessel images 116 that are to be processed by the system 100. In some cases, the new nadir vessel image 116 may be a plurality of images of the same vessel. In some cases, the image 116 (and known images used for matching) may be panchromatic or greyscale. In other cases, the image 116 (and known images used for matching) may be RGB images. RGB images may be preferred, as such images generally provide more useful information for matching (i.e., colour).

The new nadir vessel image 116 may contain a suspicious dark vessel (“vessel of interest” or “unknown vessel”) whose trajectory has been identified. The trajectory may be represented by the time and location of a detection. The time and location of a new nadir image are used to select which known vessel images to put in a candidate list. The candidate list includes a set of known oblique images that are compared (matched) to the unknown nadir image by the nadir-oblique image matcher. The candidate list may be selected or determined by a feasible ship finder module or component. The time and location of the new nadir image may be encoded with the image. The time and location may be encoded by the satellite that captured the image. A trajectory of two or more detections can be formed by associating multiple detections with each other due to the proximity of their locations at the times of detection, combined with other characteristics of the detections such as object size or velocity. The feasible ship finder component identifies whether two detections could possibly belong to the same trajectory or not and removes candidate vessels (e.g., in a database of known oblique images) from the candidate list that could not possibly be the same object due to their last known location. In some embodiments, the trajectory of an unknown nadir image is only required to have one time/location. The enables the feasible ship finder to provide a sufficiently short candidate list, which may avoid a scenario where every existing ship is a candidate. The trajectory ship in the new nadir image comes from the satellite image itself, not AIS, as it has not yet been correlated with an AIS data.

In some cases, the new nadir vessel image 116 is a cropped new nadir vessel image. For example, an optical nadir satellite image may be processed to detect a vessel of interest in the image. This may be performed, for example, by providing the optical nadir satellite image as input to an object detection model trained to detect one or more classes of vessels of interest in the input image. Detecting may include localizing the vessel in the image (e.g., via a bounding box) and assigning a class label to the vessel. In some cases, a confidence level may also be determined and provided. In some embodiments, the system 100 may include an object detection model for performing vessel detection in nadir satellite images. An annotated version of the nadir satellite image (e.g., annotated with object location/bounding box data) may then be provided as input to a cropping module configured to crop the detected vessel out of the nadir satellite image. In some embodiments, the cropping module may be a component of system 100, for example executed by processor 104. The cropping module generates a cropped new nadir vessel image that includes the detected vessel of interest. In cases where multiple vessels have been detected in an image, a corresponding number of cropped nadir images may be generated.

The processor 104 includes a nadir-oblique vessel image matcher 118. The nadir-oblique vessel image matcher 118 may also be referred to as an overhead-oblique image matcher 118 (or simply “image matcher 118”). The nadir-oblique image matcher 118 compares images of potentially the same object from nearly orthogonal views (i.e., nadir/overhead and oblique).

The nadir-oblique vessel image matcher 118 determines if the vessel in the new nadir vessel image 116 is the same vessel as a vessel contained in an oblique vessel image 112. The matching of nadir to oblique images as performed by the nadir-oblique image matcher can be significantly more difficult than oblique-oblique or nadir-nadir image matching, due to what can be extreme difference in viewing angles.

The nadir-oblique vessel image matcher 118 may use or build on techniques including cross-view image matching of geographic locations in images, as well as object (e.g., vessel) re-identification. The nadir-oblique vessel image matcher 118, and the system 100 generally, combines these techniques and applies them in a new direction for vessel re-identification via cross-view image matching.

The nadir-oblique image matcher 118 is configured to determine a specific identity of the unknown vessel based on known identities of vessels in the database 110. The determined specific identity of the unknown vessel is represented in the system 100 as an assigned unique vessel identifier. The format of the assigned unique vessel identifier is the same as the unique vessel identifiers 114. In an embodiment, the assigned unique vessel identifier is an MMSI number. Generally, the nadir-oblique image matcher 118 may determine and assign the unique vessel identifier to the new nadir satellite image 116 based on a comparison of the image 116 to one or more oblique images 112 in the database 110. In FIG. 1, new nadir satellite image 116 has been assigned unique identifier 120, wherein the unique identifier 120 identifies the vessel contained in the nadir image 116. The assigned unique identifier 120 is stored in the database such that the assigned unique identifier 120 is associated with the new nadir satellite image 116 and can be retrieved using the new nadir satellite image 116 (the associated is represented by line 121.

The nadir-oblique image matcher 118 includes a neural network 122 (also referred to as a “model” or “network” or “network model”). The neural network 122 is configured to receive a plurality of image pairs as input, where each image pair includes the new nadir satellite image 116 and an oblique image 112 from the database 110. The neural network 122 compares the images 116, 112 in the image pair to determine similarity. The neural network 122 outputs a ranked list 124 of known vessels in the database 110 (i.e., represented in an oblique image and having a unique vessel identifier associated therewith), the known vessels represented at least in part by their respective unique vessel identifier 114. The ranked list indicates which of the known vessels are most likely the unknown vessel in the nadir image 116.

Generally, the ranked list 124 may be configured such that a higher ranking in the list indicates a greater likelihood than a lower ranking that the known vessel (in the corresponding oblique image 112) is the same as the unknown vessel in the nadir image 116 (and thus should be assigned the same unique vessel identifier).

The nadir-oblique image matcher 118 receives as input an overhead satellite image 116 of a first vessel and an oblique image of a second vessel (each overhead/nadir image and oblique image may be referred to as a nadir/overhead-oblique image pair or image pair). For each image pair compared, the nadir-oblique image matcher 118 processes the nadir satellite image 116 and the oblique image 112 and returns a similarity score between 0 and 1 indicating how well the nadir satellite image 116 and the oblique image 112 match. The similarity score may then be translated into a determination that the compared image pair is a match (matching pair) or non-match (non-matching pair). If the pair is a match, the image matcher 118 may assign the unique vessel identifier of the matching oblique image 112 to the nadir image 116 as the assigned unique vessel identifier 120.

For example, the image matcher 118 feeds nadir satellite image 116 and oblique image 112-1 to the neural network 122. The neural network 122 compares the images 116, 112-1 and outputs a similarity score 124-1 between 0 and 1 indicating how well the images 116, 112-1 match. For example, a score closer to 1 may indicate a higher likelihood of a match, while a score closer to 0 may indicate a lower likelihood of a match. The image matcher 118 then feeds nadir satellite image 116 and oblique image 112-n to the neural network 122. The neural network 122 compares the images 116, 112-n and outputs a similarity score 124-n between 0 and 1 indicating how well the images 116, 112-1 match.

Similarity scores 124-1, 124-n are referred to collectively as similarity scores 124 and generically as similarity score 124.

In some cases, the network 122 may implement a match threshold similarity score. The match threshold similarity score is a similarity score which, if reached, is considered a “match”. The network 122 or image matcher 118 compares the similarity scores 124 to the match threshold similarity score to determine whether the oblique image 112 is a match (i.e., if the similarity score reaches the threshold, the vessel in the oblique image is considered to match the vessel in the nadir image 116). Upon detecting a match, the image matcher 118 may automatically assign the unique vessel identifier 114 of the matching oblique image to the nadir image 116 as the assigned unique vessel identifier 120. The match threshold similarity score may be set by a user, for example via a user interface of the system 100.

In some cases, the nadir-oblique image matcher 118 is configured to output, using a neural network (e.g., network 122), a ranked list of vessels 126 represented in oblique images 112 in the oblique imagery database 110 that have known MMSI numbers (or other unique vessel identifier). The ranked list 126 indicates which of the vessels in the oblique imagery database 110 are most likely the same vessel detected in the nadir satellite image 116. For example, image pairs 116, 112 processed by the nadir-oblique image matcher 118 with a higher similarity score 124 (as determined by the model 122) may cause the oblique image 112 in the respective image pair (and, more particularly, the known vessel represented in the oblique image) to be ranked higher on the ranked list 126 than an oblique image 112 of an image pair with a lower similarity score 124. For example, the ranked list 126 may include oblique images 112 in the oblique imagery database 110 ranked from highest similarity score to lowest similarity score as determined by the nadir-overhead image matcher model 122. In some cases, a threshold may be implemented whereby only those oblique images with a similarity score 124 above a certain predefined similarity threshold are included in the ranked list 126.

It should be noted that the task of overhead-oblique image matching performed by the image matcher 118 can be considerably more challenging than an overhead-overhead image matching task, due to the different viewing angles of the observed ship/object in the overhead image 116 and oblique image 112. For example, in the present task of comparing overhead and oblique images 116, 112, features visible from the side of the ship (i.e., in an oblique image 112 of the ship) may be completely occluded from the nadir viewing angle (and, not present or visible in the overhead image 116 of the ship).

The nadir-oblique image matcher 118 may be incorporated into a system for vessel identification. The identification task performed by the nadir-oblique image matcher 118 (namely, nadir-oblique image matching) may be considered a subtask of an overall vessel identification task performed by the vessel identification system. Other subtasks are also performed by the vessel identification system. For example, the vessel identification system may include other image matchers where the image pairs being compared are of a different type than overhead-oblique optical image pairs. In an embodiment, other image matchers may include an overhead-overhead (or nadir-nadir) image matcher and a SAR-SAR image matcher. Each image matcher type may include a machine learning-based model configured to compare two image sources at a time (e.g., nadir images vs. nadir images, nadir vs. oblique, SAR vs SAR etc.). The models may process the specific type of image pair and output or return a similarity score indicating how similar the two images in the processed image pair are (and thus how likely it is that the ship contained in each image of the image pair is the same). In some cases, the similarity score may be translated into a match determination. The match determination classes or categories may include a match class (for matching image pairs) and a non-match class (for non-matching image pairs). In some cases, the similarity score or match determination of the image matcher 118 may be fed to a downstream process or model (e.g., along with similarity scores or match determinations from one or more other types of image matchers) that determines, based on the received outputs from the different image matchers, an overall match determination.

A particular embodiment of the nadir-oblique image matcher 118 and nadir-oblique image matcher model 122 will now be described.

In this embodiment, the nadir-oblique image matcher 118 uses a repurposed Siamese network as network 122.

An example Siamese-like network architecture that may be implemented by network 122, according to an embodiment, is shown in FIG. 15.

Referring now to FIG. 15, shown therein is a Siamese-like network 200 that may be implemented by the nadir-oblique image matcher 118 for determining whether a nadir image and oblique image match, according to an embodiment. The Siamese-like network 200 may be implemented as a component of the neural network 122 of FIG. 1.

Generally, the Siamese-like network 200 is an artificial neural network that uses two encoder branches with identical architecture but different weights while working in tandem on two different input vectors to compute comparable output vectors. In some cases, one of the output vectors may be precomputed (e.g., an output vector generated from known oblique image 112), which forms a baseline against which the other output vector (e.g., an output vector generated from nadir satellite image 116) is compared.

The Siamese-like network 200 includes convolutional neural networks (CNNs) 202a, 202b. The CNNs 202a, 202b do not share weights. It should be noted that, in variations, nadir image 116 and known oblique image 112 may be processed by the network 200 at the same time (or roughly the same time) or at different times (e.g., if known oblique image 112 is processed ahead of time and the output compared to an output generated from the nadir image 116 when processed).

The CNN 202a generates embeddings 206a of the nadir image 116. The CNN 202b generates embeddings 206b of the known oblique image 112. The embeddings 206a, 206b may be stored in memory 102.

The network 200 compares the embeddings 206a, 206b by executing a Euclidian distance computation 208 using the embeddings 206a, 206b as input to obtain a Euclidian distance output ‘d’ 210. The distance d 210 may be stored in memory 102. The distance d is used in the same way as the similarity score, with the distance d and similarity score having an inverse relationship. The larger the distance between two embeddings, the less likely they match, and the smaller the distance, the more likely they match.

Referring again to FIG. 1, once identified, the nadir image 110 (and the database more generally), may then be used as a nadir image containing a known vessel in a nadir-nadir image matching system in which a nadir image containing an unknown vessel is compared to nadir images containing known vessels to identify matching vessels using a machine learning model, such as one similar to the nadir-oblique image matcher described herein.

In some embodiments, the system 100 may configured to execute a user interface module configured to display a graphical user interface including a graphical representation of the ranked list 126 and receive a user input selecting a known oblique image from the ranked list 126. The assigning of the identifier may include assigning, in response to the user input, the known vessel identifier associated with the selected known oblique image to the unknown nadir image 110. The graphical representation of the ranked list 126 may include, for each known oblique image in the ranked list, a visual representation of the known oblique image.

In some embodiments, assigning the known unique vessel identifier to the unknown nadir image 110 may be performed automatically without user input by the nadir-oblique image matcher 118 based on the similarity score of a known oblique image associated with the known unique vessel identifier exceeding a predetermined threshold similarity score. In some embodiments, the system 100 may be configured to execute a user interface module configured to display a graphical user interface including the automatic assignment of the known vessel identifier to the unknown nadir image and a visual representation the known oblique image associated with the known unique vessel identifier and the unknown nadir image; and receive a user input confirming or rejecting the assignment.

Referring still to FIG. 1, an example training technique for the neural network 122 of the nadir-oblique image matcher 118, according to an embodiment, will now be described. The neural network 122 is trained on pairs of nadir and oblique images to learn which pairs match and do not match. This is limited by the number of image pairs that can be collected in the nadir-oblique dataset. However, there are many ships (or, more generally, objects) with multiple oblique images per ship, but no nadir images paired. Similarly, there are some ships with multiple nadir images per ship, but no oblique images paired. For the nadir-oblique image matcher 118 to benefit from this other data, the nadir-oblique image matcher network 122 has its two encoder branches separated and duplicated, so that the nadir branch can be pretrained on nadir-nadir image pairs and the oblique branch can be pretrained on oblique-oblique image pairs. This helps the nadir-oblique image matcher network 122 to learn what are important distinguishing features of nadir images of ships and oblique images of ships, respectively. After pretraining the two branches in this way, the two branches are re-combined and then trained on the nadir-oblique image pairs. Comparing a model 122 that was trained only on the nadir-oblique image pairs, with a model 122 that was pretrained in the manner described above, it has been found that the model with pretraining benefitted significantly.

In an embodiment, the repurposed Siamese-like network 122 may be SAFA-net. SAFA-net can be used for cross-view image matching of geospatial location images taken from satellite and ground views.

In an embodiment, the Siamese-like network model 122 uses a customized VGG16 visual encoder to generate image features and a multi-headed attention mechanism. The multi-headed attention mechanism performs spatially aware feature aggregation to learn which features to match across viewpoint domains. The nadir-oblique image matcher model 122 takes in data from a large number of locations, each with a single satellite image and ground-view image pair and learns that images from the same locations match while images from different locations do not match. Unlike traditional Siamese-like networks, which use a binary or triplet loss with a matching or non-matching pair or both, the SAFA-net instance 122 encodes a batch of N pairs at a time with a loss function that minimizes the distance between corresponding pairs and maximizes the distance between all non-matching pairs within the batch. Although SAFA-net was originally designed for image pairs with only a single image from each viewpoint, the SAFA-net instance in the nadir-oblique image matcher model 122 is modified to handle vessel images for which we may have multiple images per vessel in either viewpoint for training.

The SAFA-net instance in the nadir-oblique image matcher model 122 includes a different convolutional neural network (“CNN”) encoder for encoding the nadir images and oblique images (“first and second encoder branches”). Accordingly, the nadir-oblique image matcher model 122 in this embodiment is split in two so that each encoder branch can be pre-trained on either nadir-nadir or oblique-oblique image matching, before being further trained on nadir-oblique image pairs. In other words, the first encoder branch is pre-trained on nadir-nadir image matching and the second encoder branch is pre-trained on oblique-oblique image matching. Then, the first and second encoder branches are further trained on nadir-oblique image pairs.

In an embodiment, to train the SAFA-net instance of the nadir-oblique image matcher model 122 for cross-view vessel re-identification, the data is split into training, validation, and testing sets with a standard ratio of 70/10/20 percent of the data in each set, respectively.

Instead of splitting the data randomly into training and testing sets, the testing sets of the nadir-nadir datasets and the nadir-oblique datasets are aligned such that both testing sets share as many unique vessel identifiers (e.g., MMSIs) as possible, allowing for data fusion with the two testing sets where nadir-oblique and nadir-nadir image matching results can be combined to potentially give improved matching estimates (in some scenarios). In cases where there is a limited dataset for overhead-oblique training (e.g., 1750-4800 MMSIs) and a large oblique dataset that has otherwise been unused, a training, validation, and testing set splitting for oblique-oblique image matching may be created. In a particular example, this approach resulted in ~9200 of the MMSIs that had <4 images were used for a test set. To track how well the networks are learning the training data, a subset of training images that were seen during training (but not necessarily each epoch or in the same pair) may be selected to make trainVal subsets with the same number of MMSIs as their respective test sets (a trainVal includes images that have been seen in training but may not have been paired together and not necessarily seen in each epoch). A main goal of this oblique-oblique image matching is to pre-train the network on many images of ships so that the network has more data to learn relevant ship features to extract, and then transfer these weights to a new network trained to match overhead (nadir)-oblique image pairs.

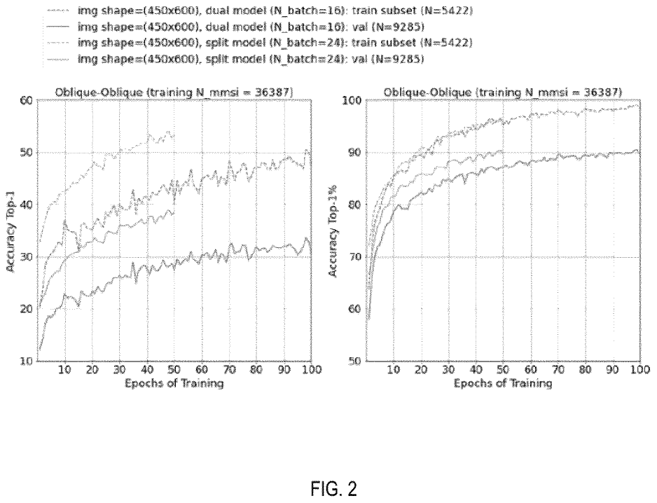

In an embodiment, a SAFA-net is used for oblique-oblique ship image matching with input image shapes of 450×600 pixel shapes to obtain pretrained weights for later use with a SAFA-net for nadir-oblique image matching by the nadir-oblique image matcher 118. Training results of example experiments are shown up to 100 epochs in FIG. 2. During training, we monitor both top1 and top1% accuracy in both a subset of the training data, the trainVal set, as well as the validation set.

In some embodiments, the model is split into two branches. Splitting the model into two branches may enable training the nadir branch on its own with reduced (e.g., half as many) model parameters stored on the processor (e.g., GPU). This may allow for larger batch sizes to be used and training the model to equal or greater accuracy in half as many epochs of training as a dual branch model. Splitting into two branches as described above is illustrated in the Siamese-like network of FIG. 15 (described further below). One branch receives the unknown nadir image and the other branch receives a known oblique image. In this case, the branches do not share weights. The model is a Siamese-like network and uses two branches. Each branch may be pretrained on its own, such as described herein, in which case it is duplicated in a new Siamese network in which the duplicates are identical and share their weights.

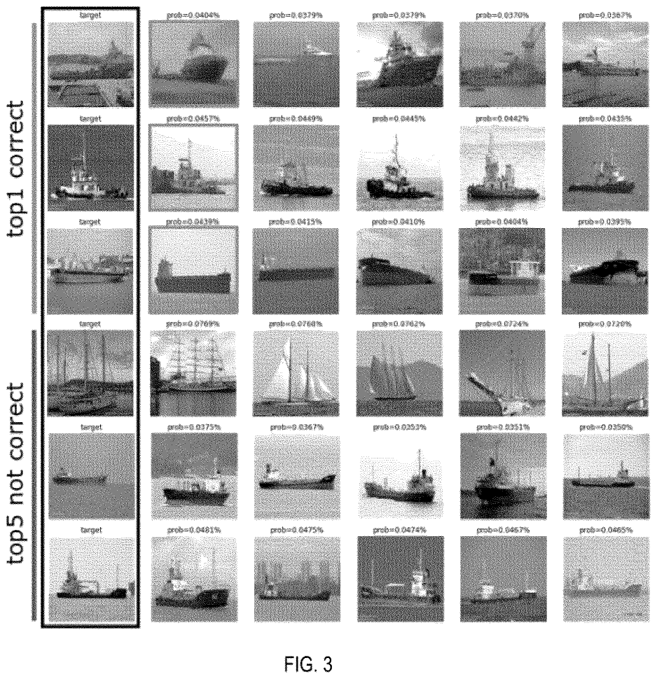

The top 5 vessel images that the model considers most similar may be plotted to see if the model is at least making reasonable choices by the standards of a human. It should be recognized that, in an example, the model may be ~9000 vessels in a second, something that would take a human operator much longer to achieve. In FIG. 3, a plot shows the target vessel to the left, as well as the top 5 candidate vessels to the right. In the top 3 rows are selected examples where the model got the correct vessel as its top 1 choice and it can be seen that the other four next best choices all look very similar. In the bottom 3 rows, examples are selected examples in which none of the top 5 choices are correct, but again it can be seen that they all look visually very similar to the target vessel. In some of these cases, careful analysis by a human expert may be able to distinguish the correct from incorrect matching images but this would likely take a long time to go through 9000 images and benefit significantly from having a list of candidate vessels reduced to 1% if its size.

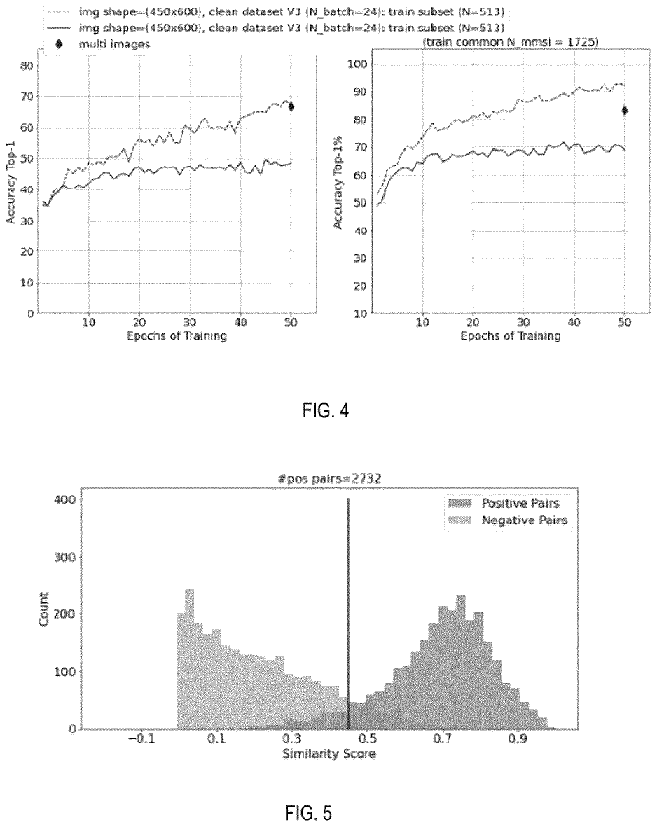

Next, a nadir branch may be pretrained using nadir-nadir image pairs. This branch of the model can then be used to perform nadir-nadir image matching, and can be used as a starting point when later training a nadir-oblique image matching model (e.g., network/model 122). Example results of training the nadir-nadir model are shown in FIG. 4. Here the accuracy shown for the test set during training uses two nadir images per MMSI making it a one-to-one image matching problem. After training has finished, the similarity scores were averaged over all available nadir images and average them to produce multi image accuracy shown by a blue diamond. A top1 accuracy of ~69% and a top1% accuracy of ~82% can be seen.

Although the top1 and top1% accuracies are used to assess the model's performance during and after training, this is a metric that applies to how well an image can be matched with the correct image out of a finite set of several hundred options, by having the best matching score. However, in an operational scenario it may be desirable to consider whether two images match, without considering the entire set of possibilities. In this scenario, there is a question of what is the probability that the model correctly identifies matching pairs or falsely identifies a match when the images are not of the same ship. These are the Probability of Detection (PD) and the Probability of False alarm (PFa), respectively, and can readily calculated as follows. First, create a list of all possible matching image pairs is created, and another of equal length with a random selection of non-matching pairs is created. For all pairs, the matching scores are calculated from the feature vectors output by the model, which can be plotted as illustrated in FIG. 5.

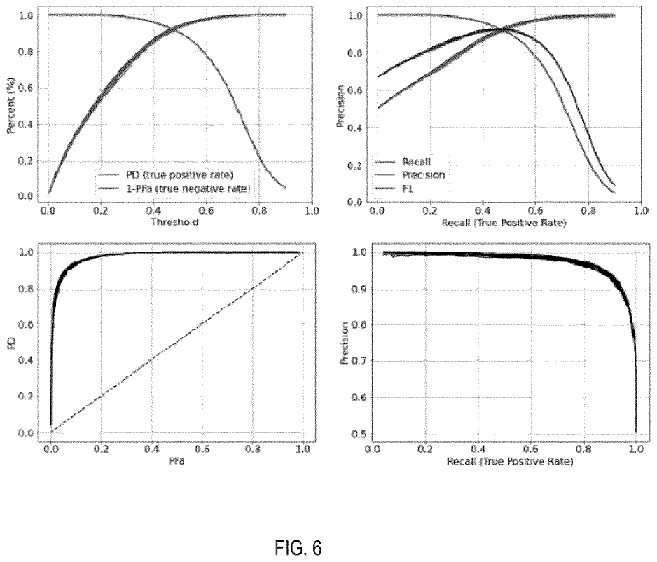

Here it can be seen that the negative and positive pairs result in two score distributions with clearly distinct peaks but overlapping tails. In order to calculate the detection and false alarm rates, a threshold is set to many possible values between zero and one. For each threshold value, it is determined that scores below are predicted not to match and scores above threshold are predicted to match. An example threshold is shown by a vertical black line in FIG. 5, which shows that false predictions come from the overlapping tails of the two distributions. In addition to the PD and PFa rates, the precision and recall for each threshold can be calculated as well as the F1 score which is an overage of the two. The threshold that results in the greatest F1 score is generally considered the optimal threshold with which to make predictions, however by plotting PD versus 1-PFa, as shown in FIG. 6, it can be seen that the threshold sets a tradeoff between maximizing PD without allowing too much PFa. The optimal threshold is estimated to be 0.45, for which we have a detection probability of PD=0.94 and a false alarm rate of PFa=0.09. Because there are so many more possible negative pairs than positive pairs, the negative pairs were randomly selected 20 times, and these statistics we calculated multiple times to get a sense of the variability and found these probabilities to have a standard deviation of ~+/−0.01.

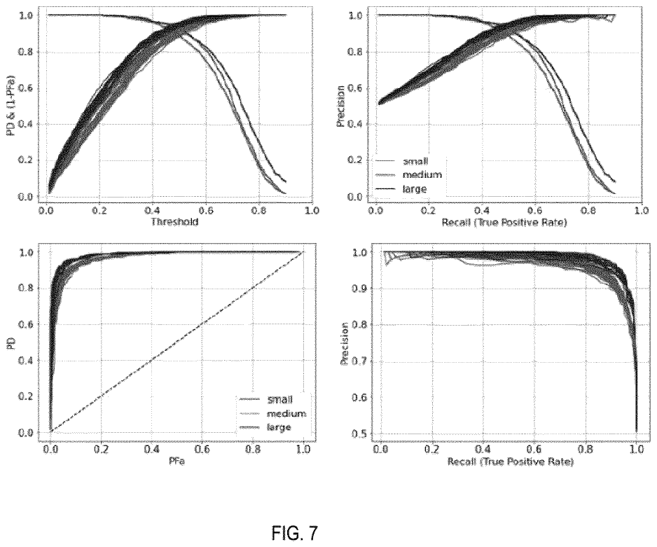

In order to integrate length information estimated about the vessel in the nadir images, in a Bayes optimal way, we need to know how much these results are dependent on the vessel's length. To get an idea of level of this dependency, we divide our vessels up into three length categories including small, medium, and large, with arbitrary thresholds to give a similar number of vessels per length class. In this case, small ships are less than 72 m long, medium ships are less than 95 m but greater than 72 m, and large ships are greater than 95 m. We then regenerated our lists of positive and negative pairs from within each length grouping and recalculated the probabilities above. In this case we plot the detection probabilities again for each of the three vessel length classes in FIG. 7 below, and find rates of PD=0.93, 0.92, 0.95, and PFa=0.10, 0.10, 0.07 for the small, medium, and large classes respectively.

Here we can see that there is a bit more variability between curves due to the reduced number of possible image pairs in each length class. Although the performance on large ships is slightly better, as would be expected due to the clearer satellite images, we expect that this may have a more significant effect when matching nadir satellite image to an oblique image which may have considerably more details for the models to use to match images.

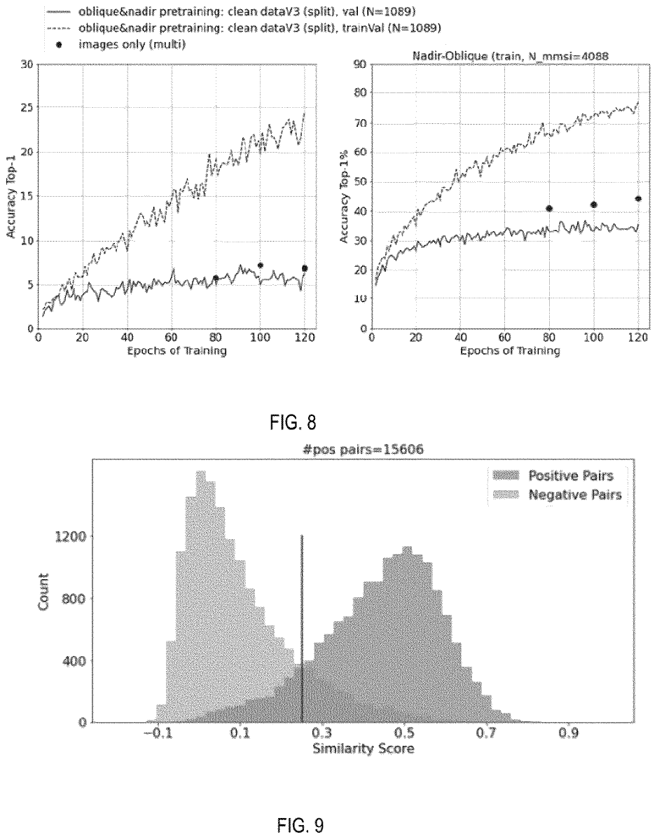

Next, a nadir-oblique image matcher is trained, using the nadir-nadir and oblique-oblique pretrained models as starting points. The training results for this model are shown in FIG. 8, and although the result when starting with imagenet weights are not shown, the pretraining of each separate encoder branch does result in a significant increase in prediction accuracy.

Although the top1 and top1% accuracy of the nadir-oblique model is significantly lower than that of the nadir-nadir and oblique-oblique models, it should be noted that this is a considerably more difficult task, even for a human operator. In many cases, features visible from the side are simply not visible from above. However, the more relevant performance metrics are the probability of detections and false alarms for binary image pairs. Similarly to what we did for the nadir-nadir image pairs, we again form sets of positive matching and negative non-matching image pairs, calculated their match scores and plotted them as a histogram, shown in FIG. 9.

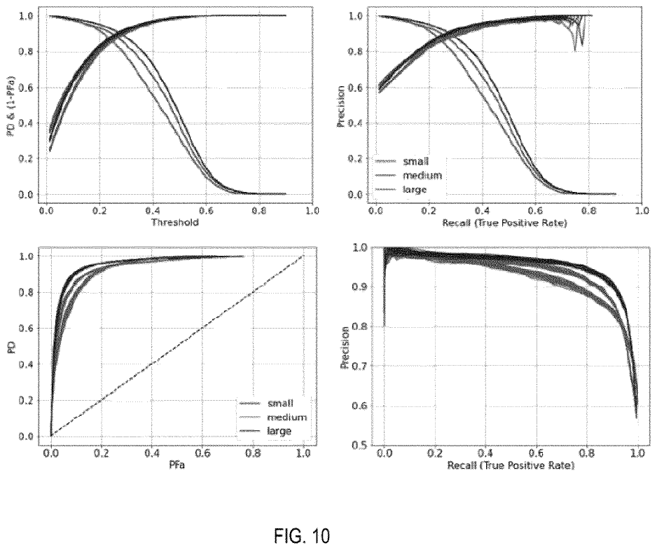

Compared to the histogram in FIG. 5, we can see that the two distributions are not as easily separated here, with a lower optimal threshold and considerably more overlap. As a result the detection probability PD=0.89, and the false alarm rate is PFa=0.13. As would be expected, these results are slightly worse than for the nadir-nadir case. However, here we have many more positive and negative image pairs, resulting in more accurate statistics. As a result, when we split these vessels into small, medium and large groups, we get much cleaner detection probability curves, as shown in FIG. 10. Compared to FIG. 7 for the nadir-nadir case, we can see here that there is a much greater separation between the curves, clearly indicating that large ships are the easiest to detect and small ships are the hardest. In this case the two thresholds for ship length classes are 70 m and 140 m, with probabilities of detection PD=0.92, 0.91, 0.91, and false alarm rates PFa=0.20, 0.16, 0.11. Here we can see that the small ships actually have the best detection rate, but they also have the worst false alarm rate.

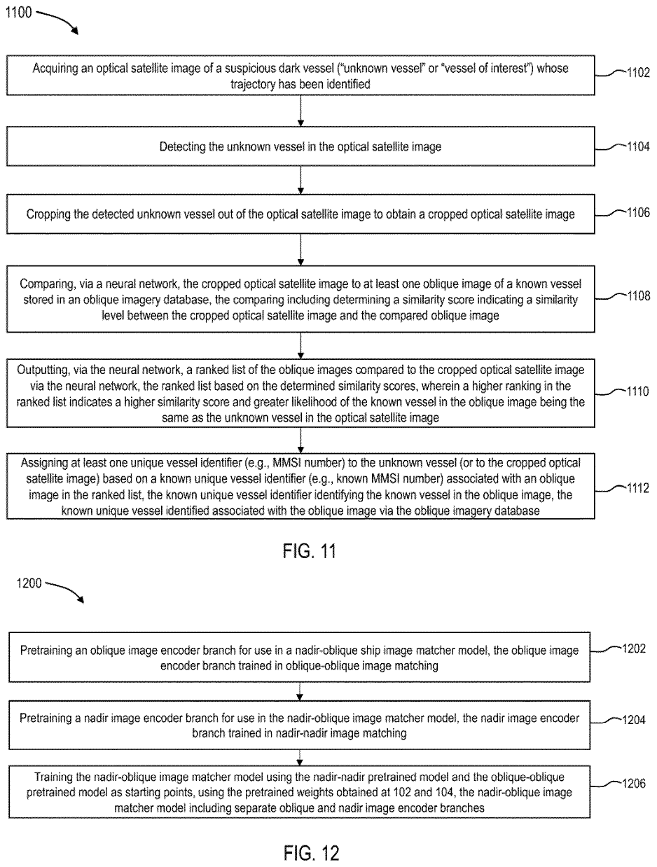

Referring now to FIG. 11, shown therein is a method 1100 of object identification using nadir optical satellite images and oblique images, according to an embodiment. The method 1100 may be encoded as computer-executable instructions and executed by one or more computing devices comprising one or more processors. In an embodiment the method 1100 may be executed by the computer system 100 of FIG. 1.

At 1102, the method 1100 includes acquiring an optical satellite image of a suspicious dark vessel (“unknown vessel” or “vessel of interest”) whose trajectory has been identified.

At 1104, the method 1100 includes detecting the unknown vessel in the optical satellite image.

At 1106, the method 1100 includes cropping the detected unknown vessel out of the optical satellite image to obtain a cropped optical satellite image.

In some embodiments, operations 1102, 1104, and 1106 may not form part of method 1100 and may have already been performed. For example, in some embodiments, the method 100 may start with an input of a cropped nadir optical satellite image containing a detected vessel of interest.

At 1108, the method 1100 includes comparing, via a neural network, the cropped optical satellite image to at least one oblique image of a known vessel stored in an oblique imagery database. The comparing includes determining a similarity score indicating a similarity level between the cropped optical satellite image and the compared oblique image.

At 1110, the method 1100 includes outputting, via the neural network, a ranked list of the oblique images that were compared to the cropped optical satellite image via the neural network at 1108. The ranked list is based on the determined similarity scores, wherein a higher ranking in the ranked list indicates a higher similarity score and greater likelihood of the known vessel in the oblique image being the same as the unknown vessel in the optical satellite image. In an embodiment, the ranked list may be saved in JSON or similar format and transferred to a visualization graphical user interface implemented at a user device.

At 1112, the method 1100 includes assigning at least one unique vessel identifier (e.g., MMSI number) to the unknown vessel (or to the cropped optical satellite image) based on a known unique vessel identifier (e.g., known MMSI number) associated with an oblique image in the ranked list. The known unique vessel identifier identifies the known vessel in the oblique image. The known unique vessel identifier is associated with the oblique image via the oblique imagery database.

Referring now to FIG. 12, shown therein is a method 1200 of training a nadir-oblique image matcher, such as the image matcher 118 of FIG. 1, according to an embodiment. The method 1200 may be encoded as computer-executable instructions and executed by one or more computing devices comprising one or more processors. In an embodiment the method 1200 may be executed by the computer system 100 of FIG. 1. For example, the processor 104 may be configured to execute one or more software modules for performing the method 1200.

At 1202, the method 1200 includes pretraining an oblique image encoder branch for use in a nadir-oblique ship image matcher model. The oblique image encoder branch is pretrained in oblique-oblique image matching.

At 1204, the method 1200 includes pretraining a nadir image encoder branch for use in the nadir-oblique image matcher model. The nadir image encoder branch is pretrained in nadir-nadir image matching.

At 1206, the method 1200 includes training the nadir-oblique image matcher model using the nadir-nadir pretrained model and the oblique-oblique pretrained model as starting points. This includes using the pretrained weights obtained at 102 and 104. The nadir-oblique image matcher model includes separate oblique and nadir image encoder branches.

In an embodiment, in order to train a nadir-oblique image matcher, such as described herein, a dataset with pairs of images (one nadir and one oblique) that are known to match is used. For example, imagine a dataset with K pairs. For a nadir-nadir image matcher (matching/comparing two nadir images to determine whether a vessel appearing in each is the same), only pairs of nadir images of the same vessel may be required (e.g., N pairs of nadir images). Similarly, for an oblique-oblique image matcher, only pairs of oblique images of the same vessel may be required (e.g., M pairs of oblique images). In practice, M is much greater than N, which is also somewhat greater than K. As such, the training approach described in FIG. 12, and in the present disclosure more generally, for training the nadir-oblique image matcher can benefit from the larger dataset with size M and N, rather than only the smaller dataset of size K.

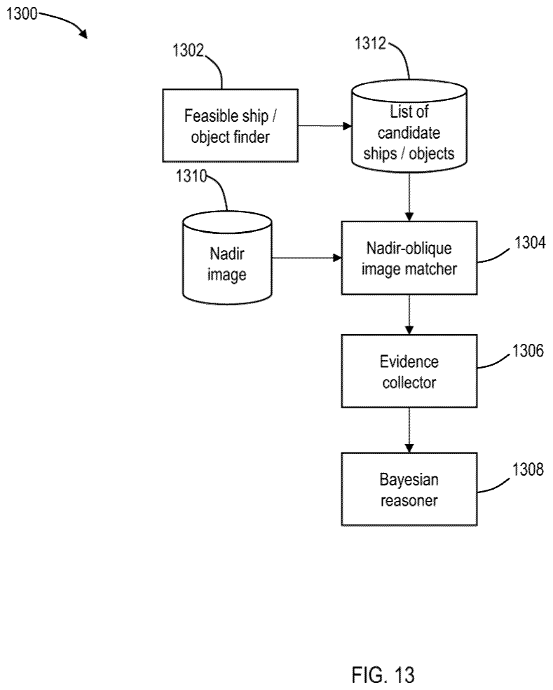

Referring now to FIG. 13, shown therein is a system 1300 for vessel reidentification using multiple image source types including satellite imagery, according to an embodiment.

The system 1300 includes a feasible ships finder module 1302, a nadir-oblique image matcher 1304, and evidence collector module 1306, and a Bayesian reasoner module 1308. The nadir-oblique image matcher 1304 may include one or more components of system 100. The nadir-oblique image matcher 1304 receives an unknown nadir image 1310 of an unknown ship and a list of oblique images of candidate ships 1312. The list of candidate ships 1312 is determined by the feasible ship finder module 1302. The nadir-oblique image matcher 1304 receives an observed ship image 1310 that was acquired by a high resolution optical satellite and a set of known candidate images 1312 (or their feature vectors). In some cases, only the feature vectors of the candidate images may be provided to and used by the nadir-oblique image matcher 1304 in the comparison (i.e., to a feature vector of the unknown nadir image generated by the matcher 1304). The known candidate images 1312 come from a database of known oblique images and are selected by the feasible ship finder 1302. The nadir-oblique image matcher 1304 outputs the candidate list with similarity scores that are ordered (i.e., a list of candidate ships ordered by similarity score). The similarity scores may be converted into probabilities of matching the observed ship (in the unknown nadir image 1310). The output of the nadir-oblique image matcher 1304 including the ordered list of similarity scores is sent to the evidence collector 1306 and eventually the Bayesian reasoner 1308. For example, the output of the nadir-oblique image matcher 1304 may be an instance of the list of candidate ships 1312 (or some subset thereof) ordered according to similarity score. Downstream the similarity score is converted into a probability of matching which can be used by the Bayesian reasoner 1308. The Bayesian reasoner 1308 may combine the matching probability with other evidence collected by the evidence collector 1306, such as how well the observed ship's estimated length and width match with those in the candidate list. In some embodiments, similarity score outputs generated by the nadir-oblique image matcher 1304 are converted into calibrated probabilities that can be combined with other probabilities or probability inputs by the Bayesian reasoner module 1308.

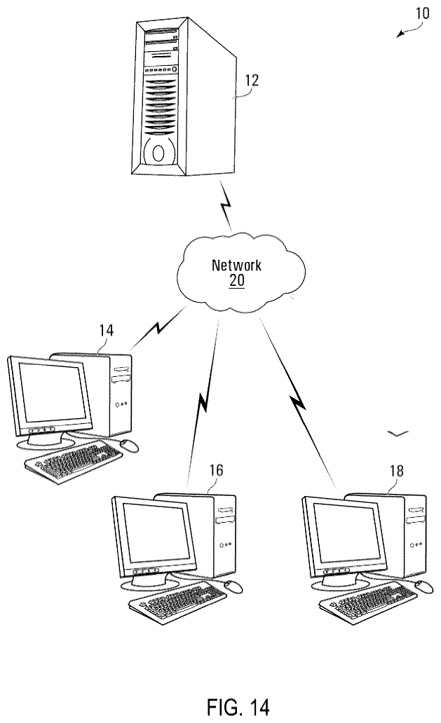

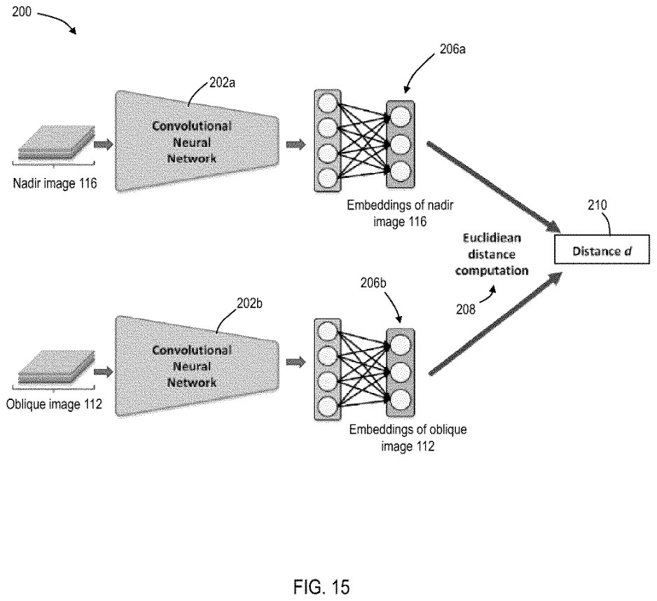

Referring now to FIG. 14, shown therein is a computer system for object identification using nadir-oblique image matching, according to an embodiment.

The system 10 includes a server platform 12 which communicates with a plurality of database server devices 14, a plurality of model training devices 16, and a plurality of user devices 18 via a network 20. The server platform 12 may be a purpose-built machine designed specifically for performing object identification (e.g., marine vessel identification) using nadir-oblique image matching.

The server platform 12, database server devices 14, model training devices 16, and user devices 18 may be a server computer, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20. Input device may include any device for entering information into device 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

In the description that follows, devices such as server platform 12, database server devices 14, model training devices 16, and user devices 18 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18 may send information to the server platform 12. For example, a user using the user device 18 may manipulate one or more input devices (e.g. a mouse and a keyboard) to interact with a user interface displayed on a display of the user device 18. Generally, the device may receive a user interface from the network 20 (e.g. in the form of a webpage). Alternatively, or in addition, a user interface may be stored locally at a device (e.g. a cache of a webpage or a mobile application).

Server platform 12 may be configured to receive a plurality of information, from each of the plurality of database server devices 14, model training devices 16, and user devices 18. Generally, the information may comprise at least an identifier identifying the database server, model training device, or user. For example, the information may comprise one or more of a username, e-mail address, password, or social media handle.

In response to receiving information, the server platform 12 may store the information in storage database. The storage may correspond with secondary storage of the device 12, 14, 16, 18. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The database server device 14 may be associated with a database server account. Similarly, the model training device 16 may be associated with a model training account, and the user device 18 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

While the above description provides examples of one or more apparatus, methods, or systems, it will be appreciated that other apparatus, methods, or systems may be within the scope of the claims as interpreted by one of skill in the art.

1. A computer system for computer vision-based maritime surveillance and identification of unknown vessels, the system comprising:
at least one data storage device storing:
a database of optical oblique images each containing a known candidate vessel, each known candidate vessel having a known unique vessel identifier associated therewith that is stored in the database and which identifies the known candidate vessel; and
an optical nadir satellite image containing an unknown vessel; and
at least one processor configured to execute a nadir-oblique image matcher, the nadir-oblique image matcher configured to:
compare, via a neural network, the nadir image to a plurality of oblique images in the database, the comparing including determining a similarity score indicating a similarity level between the nadir image and a respective oblique image;
output, via the neural network, a ranked list of the oblique images, the ranked list based on the determined similarity scores, wherein a higher ranking in the ranked list indicates a higher similarity score and greater likelihood of the known vessel in the oblique image being the same as the unknown vessel in the nadir image; and
assign a known unique vessel identifier to the nadir image based on the ranked list.

2. The system of claim 1, wherein the nadir-oblique image matcher is further configured to store the nadir image and the assigned known vessel identifier in association with the nadir image in a database of nadir images containing known vessels for use by a nadir-nadir image matcher.

3. The system of claim 1, wherein the at least one processor is further configured to execute a user interface module configured to display a graphical user interface including a graphical representation of the ranked list and receive a user input selecting an oblique image from the ranked list, and wherein the assigning includes assigning, in response to the user input, the known vessel identifier associated with the selected oblique image to the nadir image.

4. The system of claim 1, wherein the graphical representation of the ranked list includes, for each oblique image in the ranked list, a visual representation of the oblique image.

5. The system of claim 1, wherein assigning the known unique vessel identifier to the nadir image is performed automatically without user input by the nadir-oblique image matcher based on a similarity score of an oblique image associated with the known unique vessel identifier exceeding a predetermined threshold similarity score.

6. The system of claim 1, wherein the at least one processor is further configured to execute a user interface module configured to: display a graphical user interface including the assignment of the known vessel identifier to the nadir image and a visual representation of the oblique image associated with the known unique vessel identifier and the nadir image; and receive a user input confirming or rejecting the assignment.

7. The system of claim 1, wherein the unique vessel identifier is a maritime mobile service identify number.

8. The system of claim 1, wherein the neural network is a Siamese-like neural network configured to receive a plurality of image pairs as input, each image pair including the nadir image and an oblique image from the database, the Siamese-like neural network comprising two encoder branches having an identical architecture with different weights.

9. The system of claim 1, wherein a trajectory comprising a time and location of the unknown vessel is encoded with the nadir image and used by the at least one processor to determine the plurality of oblique images to which the nadir image is compared by the nadir-oblique image matcher.

10. The system of claim 1, wherein the plurality of oblique images represents a list of candidate vessels identified by a feasible vessel finder module based on a trajectory of unknown vessel in the nadir image.

11. The system of claim 10, wherein the at least one processor is further configured to execute the feasible vessel finder module to obtain the list of candidate vessels.

12. The system of claim 1, wherein the nadir image has only one time and location encoded therewith that is used to determine the plurality of oblique images for comparison with the nadir image via a trajectory analysis.

13. The system of claim 8, wherein the Siamese-like neural network includes a first encoder branch pretrained with a nadir-nadir image dataset and a second encoder branch pretrained with an oblique-oblique dataset.

14. The system of claim 13, wherein after individual pretraining of the first and second encoder branches, the first and second encoder branches are trained together on a nadir-oblique dataset comprising pairs of nadir and oblique images.

15. A method of computer vision-based maritime surveillance and identification of unknown vessels, the method comprising:
comparing, via a neural network, a cropped nadir image to at least one oblique image of a known vessel stored in an oblique imagery database, the comparing including determining a similarity score indicating a similarity level between the cropped nadir image and the compared oblique image, the oblique image containing a known candidate vessel having a known unique vessel identifier associated therewith that is stored in association with the oblique image and which identifies the known candidate vessel;
outputting, via the neural network, a ranked list of the oblique images that were compared to the cropped nadir image, the ranked list based on the determined similarity scores, wherein a higher ranking in the ranked list indicates a higher similarity score and greater likelihood of the known vessel in the oblique image being the same as the unknown vessel in the nadir image; and
assigning at least one unique vessel identifier to the cropped nadir image based on the ranked list.

16. The method of claim 15, further comprising identifying a trajectory of the unknown vessel in the nadir image and using the trajectory to identify a subset of the oblique images in the oblique imagery database for comparison to the nadir image.

17. A method of training a nadir-oblique image matcher model for computer vision-based object tracking, the method comprising:
pretraining an oblique image encoder branch for use in a nadir-oblique image matcher model, the oblique image matcher encoder branch trained in oblique-oblique image matching;
pretraining a nadir image encoder branch for use in the nadir-oblique image matcher model, the nadir image encoder branch trained in nadir-nadir image matching; and
training the nadir-oblique image matcher model using the nadir-nadir pretrained model and the oblique-oblique pretrained model, using pretrained weights obtained from pretraining the oblique image encoder branch and pretraining the nadir image encoder branch in the nadir-oblique image matcher model;
wherein the nadir-oblique image matcher model includes separate oblique and nadir image encoder branches.
